(19) United States
(12) Patent Application Publication
(10) Pub. No.: US 2017/0039632 A1
(43) Pub. Date: Feb. 9, 2017

(54) TRACKING ASSETS WITHIN A GEOFENCED AREA

(71) Applicants: Todd Meagher, Keller, TX (US); Darren Rodgers, Keller, TX (US)

(72) Inventors: Todd Meagher, Keller, TX (US); Darren Rodgers, Keller, TX (US)

(21) Appl. No.: 15/299,144

(22) Filed: Oct. 20, 2016

(51) Int. Cl. G06Q 30/06; H04W 8/00; H04W 4/00; H04L 29/08; G06K 7/10; H04W 4/02

(52) U.S. Cl. CPC G06Q 30/0645; G06K 7/10366; H04W 4/021; H04W 4/008; H04L 67/34; H04W 4/02; H04W 8/005

(57) ABSTRACT

A system for tracking assets with a geofenced area is provided. The system comprises a processor, a memory, and a geofence application stored in the memory that when executed on the processor receives a first message from a client device located at a remote premises, the first message containing a record of a short term loan of an asset by the premises, the record further containing a first data item and a second data item. The system also stores the record in the database, the record associating the first data item, the second data item, and identification of the premises and further describing a due date and time for return of the asset under the loan. The system also receives a second message from the client device indicating return of the asset. The system also converts the record to closed status based on receipt of the second message.

### CROSS REFERENCE TO RELATED APPLICATIONS

None

### FIELD OF THE DISCLOSURE

The present disclosure is in the field of tracking assets. More particularly, the present disclosure is in the technical field of tracking and locating assets within defined physical areas using electronic technologies.

### BACKGROUND OF THE DISCLOSURE

Hotels, resorts, health clubs, hospitals, universities and other institutions regularly lend out lightweight and other items on short term loans to their guests, employees and students. Hotels, resorts and health clubs may lend towels, robes and sporting equipment to guests. Hospitals may lend scrub uniforms, lab equipment and electronic and other devices to physicians, staff and other employees. Universities may lend out books, light electronic devices and lab equipment to students. Military bases may lend out equipment of many kinds to personnel. These institutions lose many thousands of dollars every year due to non-return of such assets provided on short term loan. While an institution's assets out on loan to guests and others at a given time are valuable when taken collectively, each asset by itself may not be of significant value relative to the size of the institution's other assets, costs and revenues. Managing such relatively small assets can be a time consuming and expensive process considering the management attention and direct labor required in documenting, tracking and recovering the assets.

### SUMMARY OF THE DISCLOSURE

In embodiment, a system for tracking assets with a geofenced area is provided. The system comprises a processor, a memory, and a geofence application stored in the memory that when executed on the processor receives a first message from a client device located at a remote premises, the first message containing a record of a short term loan of an asset by the premises, the record further containing a first data item and a second data item. The system also stores the record in the database, the record associating the first data item, the second data item, and identification of the premises and further describing a due date and time for return of the asset under the loan. The system also receives a second message from the client device indicating return of the asset. The system also converts the record to closed status based on receipt of the second message.

In an embodiment, a method of tracking assets within a geofenced area is provided. The method comprises a computing device creating a record based on receiving a request to borrow an asset under a short term loan. The method also comprises the computing device writing an identification of a borrower of the asset to the record based on media drawn from a keycard presented by the borrower. The method also comprises the computing device writing identification of the asset to the record and further writing a due date and time for return of the asset under the loan. The method also comprises the computing device transmitting the completed record to a server for storage and management of the loan.

In an embodiment, a method of tracking assets within a geofenced area is provided. The method comprises a mobile device installing and activating an electronically downloaded tracking applet. The method also comprises the mobile device causing the tracking applet to periodically receive signals from assets using Bluetooth technology. The method also comprises the mobile device, based on actions of the tracking applet, detecting proximity of at least one asset further based on physical attachment of at least one Bluetooth device to the at least one asset. The method also comprises the mobile device reporting location of the at least one asset to a remote server.

### BRIEF DESCRIPTION OF THE DRAWINGS

FIG. 1 depicts a block diagram of a system of tracking assets within a geofenced area according to an embodiment of the present disclosure.

FIG. 2 depicts a flowchart of a method of tracking assets within a geofenced area according to an embodiment of the present disclosure.

FIG. 3 depicts a flowchart of a method of tracking assets within a geofenced area according to an embodiment of the present disclosure.

### DETAILED DESCRIPTION OF THE INVENTION

Systems and methods of the present disclosure provide a geofence application for tracking of lightweight assets within a known physical premises of defined size. The assets may be on temporary short term loan to guests, employees, clients or students of an entity that owns or supervises the premises wherein the assets are intended to remain on or near the premises. A small tag is attached to each asset. The tag contains electronic devices which identify the asset itself as well as provide for the asset to be located within the premises or beyond the premises under some conditions.

A guest, employee, customer, client or student, hereafter a borrower, requests a short term loan of the asset. The borrower provides an identification card or keycard which contains a magnetic stripe or electronic media identifying the borrower. A computing device in possession of the premises, for example a tablet computer, reads the keycard furnished by the borrower and creates a record with the borrower's identifying information. In an embodiment, guest identity may be secured using a method other than reading a keycard.

The identifying information of the borrower taken from the keycard is recorded by radio-frequency identification (RFID) functionality on the computing device and combined with RFID identification of the asset stored in a small RFID device contained within the tag attached to the asset. The identifying information may be recorded using a technology other than RFID. The asset, in addition to containing the RFID device identifying the asset, also contains a Bluetooth device that also contains electronic identification of the asset and if further used to locate the asset.

The Bluetooth device and the RFID device are stored together inside the tag. The tag is physically attached to the asset in a manner that the tag does not easily become detached from the asset under repeated normal use.

In creating the record of the short term loan of the asset to the borrower, the computing device combines the identity of the borrower as recorded by the computing device from a keycard or other physical media provided by the borrower with the RFID and Bluetooth data stored on electronic devices inside the tag attached to the asset. The record of the loan combines the identity of the borrower with the identity of the asset as taken from the RFID device and the identity of the Bluetooth device contained in the tag along with the RFID device. The record also identifies the premises, for example hotel name and site identification or location, and further contains a due date and time for the asset to be returned by the borrower to the premises

The computing device transmits the record of the short term loan to a server. The server may add further information about the premises and the loan to the record. The server stores the record in a database with other records for many assets presently on short term loan from many different premises.

If the asset is not returned by its due date and time or if the asset is removed from the premises, the borrower can be contacted in an effort to secure return of the asset. The borrower may be required to make payment under terms of the short term loan for the asset not being returned under the agreed terms.

The present disclosure provides for an institution that may have multiple sites or premises, for example a hotel chain, to track and recover assets lent out to guests on a short term basis. Each asset has the small tag affixed to the asset, the tag containing electronic devices identifying the asset and further allowing for tracking and locating the asset. As noted, the presence of the Bluetooth device in the asset permits the location of the asset to be determined. The location may be determined while on the premises of the hotel, for example, from which the asset was borrowed. If the asset is carried off the premises, such action can be detected, hence the term geofenced areas that may be monitored for asset location.

Systems and methods provide for institutions such as hotel chains to have on-premises computing devices to record short term loans of such assets. The information, including at least identification of the asset, the borrower, and due date may be submitted to a central system or server that tracks many such loans for multiple premises. The central system may be independent from hotel chains or other premises and may track such loaned assets with these clients on a contract basis, for example by subscription.

Database records are created when the central system receives a message from a computing device on the premises of an entity advising of a new loan of an asset. The message contains the aforementioned information about the loan of the asset. When the asset is returned as agreed by the borrower to the hotel or other lending institution, the tag affixed to the asset is scanned by the computing device on the hotel premises. A second message is sent from the computing device to the central system. The central system accesses the database record. The return of the asset as agreed is noted and the borrower of the asset is marked in the record as released from responsibility for the asset. The record may be marked in the database as closed.

The centralized system may be located at a site remote from the hotel premises. The system may determine cases in which the asset has not been returned as agreed. The centralized system may make such determination and alert the computing device or other device on the premises. In an embodiment, the centralized system and/or the computing device may impose late charges or other penalties against an account of the borrower.

Should the asset be removed from the premises in violation of the terms of the short term loan, the computing device on the premises may detect such removal via Bluetooth signals generated by the tag attached to the asset. The borrower may initially be sent a courtesy reminder of the hotel's policy against removal of assets from the premises. Without acceptable response from the borrower, the borrower may be charged the cost of the asset or be assessed other penalty under the terms of the short term loan.

The centralized system of geofencing allows a hotel or other institution with perhaps multiple premises and hundreds or thousands of lightweight assets lent out on a daily basis to track such assets and receive compensation upon non-return of the assets. Hotels, which are primarily concerned with providing hospitality to guests, are relieved of the costly burden of tracking such valuable but small and numerous assets.

Large hotel chains may, upon receiving approval, transmit an electronic applet to mobile devices carried by their customers including registered guests and other. The electronic applet may promote guests making future hotel reservations, paying their lodging bills, and viewing hotel information. The present disclosure provides for a geofence applet to be embedded into a hotel chain's applet such that the geofence applet executes on the customer's mobile device along with the hotel chain's applet.

The geofence applet may periodically receive signals that allow Bluetooth devices of the type described herein to be located. While the computing devices may conduct their own operations to learn of locations of assets on premises that have been misplaced, lost or abandoned, beacon signals provided by the geofence applet on the mobile devices may provide for a wider search area. When guests check out and depart the premises, their mobile devices continue their Bluetooth beaconing as provided by the geofence applet. Should a person carrying a mobile device actively performing such beaconing become proximate an asset tagged as described herein, the asset may make its presence apparent. The applet may transmit information about the asset back to the centralized server or other device, potentially leading the recovery of the asset. This action may take place even when the mobile device as well as the lost, stolen or abandoned asset is far removed from the premises.

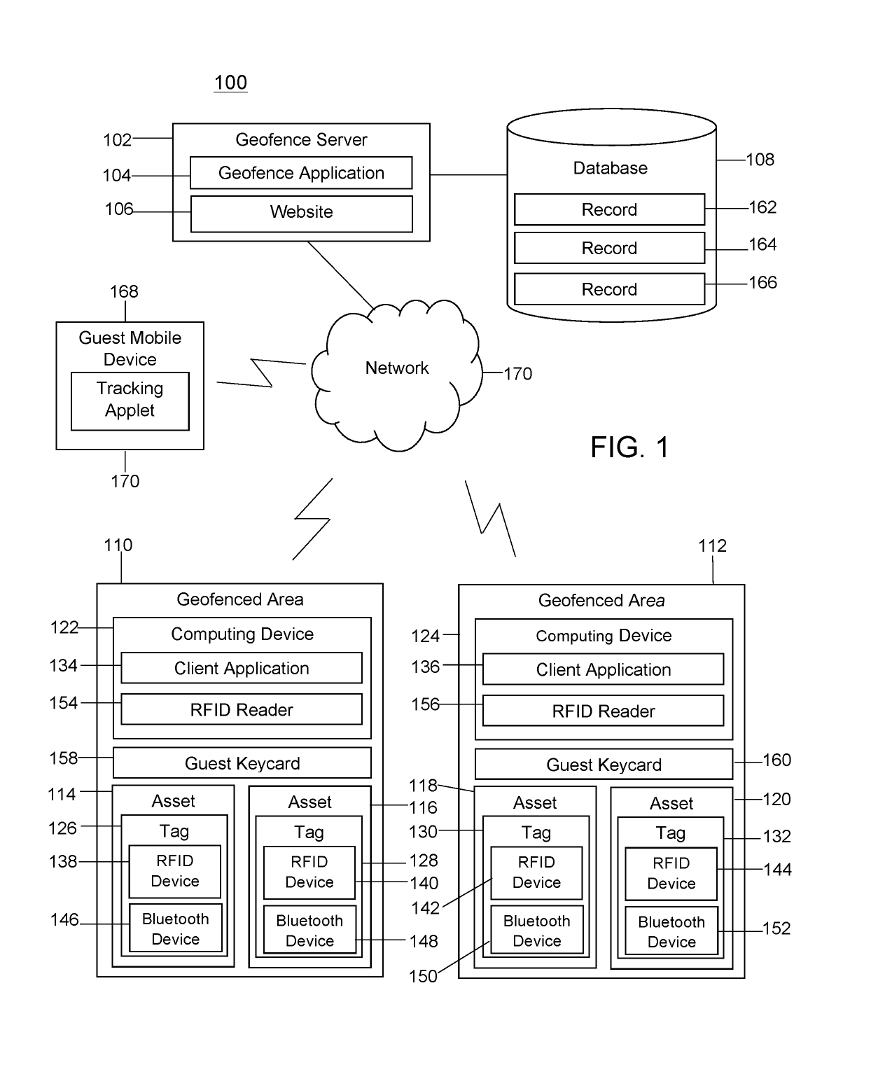

Turning to the figures, FIG. 1 is a block diagram of a system of tracking assets within a geofenced area according to an embodiment of the present disclosure. FIG. 1 depicts components of a system 100.

System 100 comprises a geofence server 102, a geofence application 104, a website 106, a database 108, geofenced areas 110, 112, assets 114, 116, 118, 120, computing devices 122, 124, and tags 126, 128, 130, 132. System 100 also comprises client applications 134, 136, RFID devices 138, 140, 142, 144, Bluetooth devices 146, 148, 150, 152, RFID readers 154, 156, guest keycards 158, 160, records 162, 164, 166, a guest mobile device 168, a tracking applet 170, and a network 172.

For purposes of brevity, the geofence server 102, a geofence application 104 may be referred to as the server 102 and the application 104, respectively. The geofenced areas 110, 112 may be referred to as the premises 110, 112, respectively, and the terms may be used interchangeably herein. The computing devices 122, 124 may be referred to as client devices. Guest keycards 158, 160 may be referred to as keycards 158, 160, respectively.

While FIG. 1 depicts two of premises 110, 112, in embodiments only one premises 110 may exist and in other embodiments more than two of premises 110, 112 may exist. Similarly, far more than two each of assets 114, 116, 118, 120 may exist per premises 110, 112 in various embodiments.

Discussion herein of a single component is assumed to apply to each instance of a component enumerated herein unless otherwise indicated. For example, discussion of asset 114 applies to assets 116, 118, 120 unless otherwise indicated. In another example, discussion of geofenced area 110 or premises 110 also applies to geofenced area 112 or premises 112 unless otherwise indicated

The server 102 is a computer system. Computer systems are described in detail hereinafter. In an embodiment the server 102 may comprise more than one computer system.

The application 104 executes on the server 102 and receives messages from the computing device 122 located at premises 110 about assets 114, 116 loaned to customers on a short term basis. Premises 110 may be a hotel or resort. Guests of the premises 110 carry guest keycards 158, 160 while registered with the premises 110 and use the keycards 158, 160 to access their rooms or suites and purchase food, beverages and other items while registered. Guests also use their keycards 158, 160 to borrow assets 114, 116, for example towels, robes, sporting equipment, beach umbrellas and other lightweight items on a daily or other short term basis.

The application 104 tracks assets 114, 116 loaned out by numerous premises 110, 112. Information tracked includes the identity of the premises 110 and the identity of guests borrowing assets 114, 116. The application 104 also tracks expected return dates and times of the assets 114, 116 and identity of the particular asset 114 loaned to the guest.

The application 104 may deal with numerous hotel and resort operators on a contract basis, each of the operators having one or more premises 110, 112. Such hotels and resorts on a daily basis may loan out to guests a large quantity of assets 114, 116 and expect the assets 114, 116 to be promptly returned and in good condition. Managing the loaning and recovery of such assets 114, 116 may be a time-consuming and labor intensive process. Such assets 114, 116 in large quantities are valuable to the hotels and resorts and may be difficult and expensive to replace when lost.

The computing devices 122, 124 are computers used by the premises 110, 112 to record loans of assets 114, 116 and transmit the information to the server 102 for processing by the application 104. In an embodiment, the computing devices 122, 124 may be tablet computers or other mobile devices or may be laptop or desktop computers. The computing devices 122, 124 are equipped with scanning and data reading and gathering functionality to read and record data as described herein from keycards 158, 160 and from the media contained within tags 126, 128, 130, 132.

When a guest wishes to borrow an asset 114, the guest produces his/her keycard 158. A client application 134 executing on the computing device 122 creates a new record 162 for the transaction. The RFID reader 154 executing on the computing device 122 extracts information from the keycard 158 about the guest. The client application 134 populates the record 162 with identifying information about the guest including name and account or room number. The record 162 also includes expected return date and time of the asset 114 the guest is borrowing.

The asset 114 contains the tag 126, a small object that may be about one inch or less in diameter. The tag 126 is physically attached to the asset 114 in a manner that the tag 126 does not easily become detached from the asset 114. In an embodiment, the tag 126 is sealed such that water or other liquids do not easily leak into the tag 126.

Inside the tag 126 is the RFID device 138 and the Bluetooth device 146. The RFID device 138 identifies the asset 114 and the Bluetooth device 146 is used to further identify and track location of the asset 114. When the guest is in the process of borrowing the asset 114, the computing device 122 scans the tag 126 and reads and writes into the record 162 the information from the RFID device 138 and the Bluetooth device 146.

The record 162 of the loan of the asset 114 contains the identity of the guest that has been captured from the keycard 158 by the RFID reader 154. The record 162 also contains the identity of the asset 114 taken from the RFID device 138 and information extracted from the Bluetooth device 146 that is used to further identify and track the location of the asset 114 while the asset 114 is on loan to the guest and afterward should the asset 114 not be returned by the expected date and time. The record 162 also contains identity of the premises 110 including name of hotel chain and site identifier.

When the client application 134 executing on the computing device 122 has fully completed the record 162 documenting the loan of the asset 114, the computing device 122 transmits the record 162 to the server 102, which in many embodiments is physically remote from the premises 110. Transmissions between the server 102 and the computing device 122 may be via wireless or wired connection. The application 104 executing on the server 102 stores the newly received record 162 in the database 108.

The application 104 monitors the record 162 for due date and time for return of the asset 114 by the guest and may send messages to the premises 110 about the loan, particularly if the asset 114 is not returned as agreed. The website 106 may be made available by the application 104 to display information about assets 114, 116 presently on loan to guests. The hotel operator may access the website 106 and view such information. The application 104 may provide a dashboard interface (not depicted in FIG. 1) for the hotel operator to view information about at least one account the hotel operator may have with a provider of the services described herein under contract. Such information viewable via the dashboard interface may include identification of the assets 114, 116 presently out on loan to guests, the premises 110, 112 associated with the loaned assets 114, 116, and information about assets 114, 116 loaned out that have not been returned as agreed.

As noted, the premises 110 is another term for the geofenced area 110. Systems and methods described herein provide the geofenced area 110 as a physical area of approximately known size and dimensions wherein the location of assets 114, 116 may be determined using at least Bluetooth technology. The geofenced area 110 is also called premises 110 because the geofenced area 110 may be the property of a hotel, resort, health club, healthcare institution or educational institution of a size wherein locations of assets 114, 116 may be determined. On a regular basis, for example daily, the computing device 122 may be activated such that the presence of specific assets 114, 116 that are out on loan may be detected.

The present disclosure envisions that the hotel, for example, may on a daily basis seek to locate assets 114, 116, for example beach or pool towels, that have been loaned to guests but have been lost, misplaced, abandoned or stolen and may still be physically on the premises 110 and within the geofenced area 110. The geofenced area 110 is referred to as such because it is a physical area within which assets 114, 116 may be located based on their having been equipped with tags 126, 128, respectively.

If an asset 114 has been removed from the boundaries of the geofenced area 110, the computing device 122 or will be unable to detect the presence of the specific sought-for asset 114. The terms of the short term loan may include a stipulation that the asset 114 may not be removed from the premises 110. If the asset 114 has not been returned by the date and time agreed and the presence of the asset 114 cannot be detected on the premises 110, the hotel operator may conclude that the asset 114 has been removed from the premises 110. The hotel operator may charge the guest's account for the asset 114 and/or take other action. Such tracking and account administration as regards the asset may be managed by the application 104, relieving the hotel operator of such management burden as discussed above.

When the hotel operator contracts with an operator of the server 102 and application 104 for the services described herein, the hotel operator provides information to the application 104 about the geofenced area 110 within the presence of certain assets 114, 116 may be determined. The geofenced area 110 may be the physical area of a property owned and/or managed by the hotel operator. The geofenced area 110 may, for example, be an entire campus including buildings, pool and beach areas, golf course, tennis courts, parking areas and maintenance buildings and may be several hundred acres in size.

The geofenced area 110 is created by the application 104 for the account of the hotel operator and may be expressed as a simple radius distance from a central point or points on the grounds of the property. Conducting the daily or regular scanning of the grounds may involve several passes about the grounds using the computing device 110 or other device that learns of presence of specific assets 114, 116 that may have been lost or abandoned on the grounds. In an embodiment, a security or maintenance officer carrying the computing device 110 may move about the grounds in a golf cart or on foot in the evening and recover such specifically sought assets 114, 116. Guests that have accidentally lost or forgotten about assets 114, 116 they borrowed from the hotel may be relieved to learn that the assets 114, 116 have been recovered and their hotel accounts not charged. The computing device 110 does not in embodiments receive Bluetooth signals from any and all assets 114, 116 that may be on the premises 110 and instead may receive signals from only specific assets 114, 116, in an embodiment specifically sought and identified unreturned assets 114, 116.

Discussion heretofore has largely been based on scenarios involving hotels or resort operators loaning out assets to guest for their short term, for example daily, use. Embodiments provided herein are not limited to such scenarios however. The teachings provided herein may also apply to a hospital that may lend out uniforms, devices, books and other lightweight assets to employees. The teachings may also apply to a university or other institution that lends out books, lab equipment, electronic devices, sporting equipment and other lightweight durable items to students and others. Military or other governmental or public facilities may loan items to persons on a short term basis.

System 100 also comprises the guest mobile device 168 and the geofence applet 170 that executes on the guest mobile device 168. In embodiments, guests of the hotel chain availing itself of the teachings herein may consent to receive electronic applets from the hotel chain for installation on their guest mobile device 168, for example a personal mobile telephone. The hotel chain's applet may promote the guest to make future reservations, view frequent lodging program points, pay lodging and restaurant bills, and view hotel chain information.

The present disclosure provides for said hotel chain applet to incorporate the geofence applet 170 as the hotel chain applet is downloaded and installed by the guest mobile device 168. The goefence applet 170 may then steadily and silently execute while conducting operations that permit certain Bluetooth devices to make their presence known. The guest, who may have the asset 114 out on loan from the premises 110, may use the geofence applet 170 to locate the asset 114 should the guest misplace the asset 114, thus relieving the guest from paying charges due to loss of the asset 114.

In an embodiment, the geofence applet 170 may continue to execute on the guest mobile device 168 after the guest has checked out of and departed the hotel. In the event the guest at a subsequent time not near the premises 110 and while carrying his/her guest mobile device 168 comes within proximity of assets 114, 116 that are property of the hotel chain, the geofence applet 170 may detect the presence of such assets 114, 116 and report such detection back to the geofence server 102.

The geofence applet 170 may make such detection and reporting despite the detected asset 114 not being the particular asset 114 borrowed by the guest during the guest's stay at the hotel. The detected asset 114 may in fact have been borrowed from and later not returned to a premises 112 owned or operated by the same hotel chain of the premises 110 but that is distant and different from the premises 110 and wherein the premises 112 is perhaps a property that the guest has never visited. The goefence applet 170 detects not just the particular borrowing guest's lost asset 114 but perhaps some other assets 114, 116, 118, 120 owned by the hotel on more than one premises 110, 112.

The geofence applet 170 may be of value to the hotel chain whose own applet may contain the geofence applet 170 because selected advertising and data gathering may be conducted by the geofence applet 170. Such advertising may be for the benefit of the hotel chain or its business partners. The data gathered may be shared with the hotel chain and may be of value to the hotel chain in developing product offerings as well as personalized offerings to the guest based on information gathered about the guest's travel, spending and communication habits.

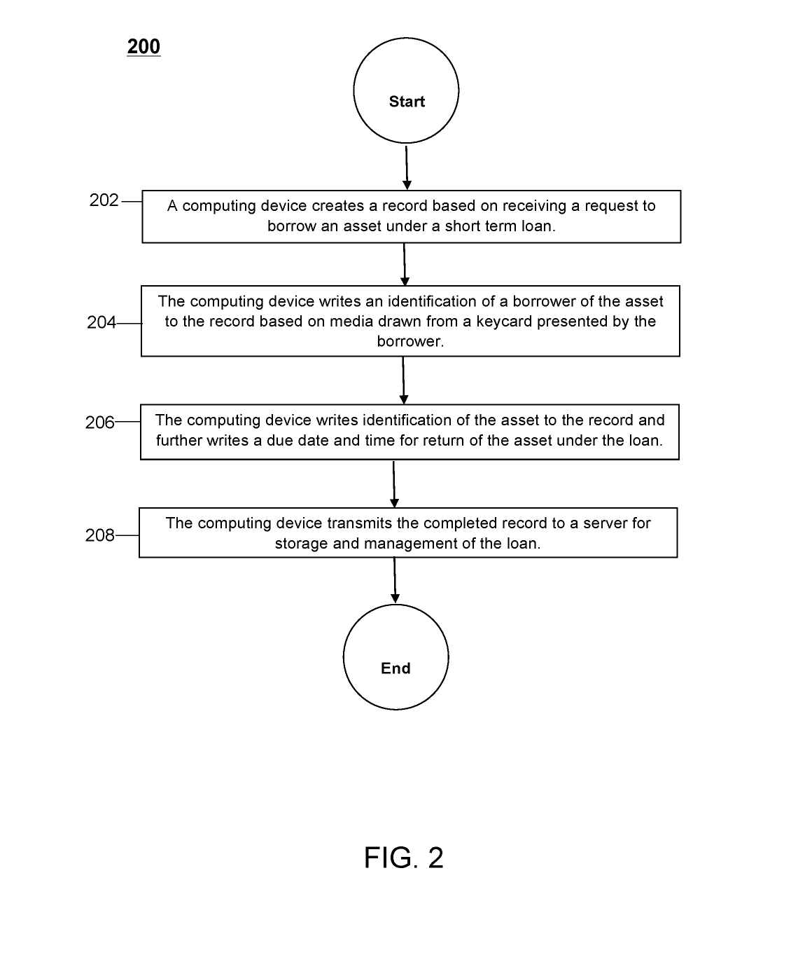

FIG. 2 depicts a flowchart of a method of tracking assets within a geofenced area according to an embodiment of the present disclosure. FIG. 2 depicts a method 200 wherein the components of the method 200 may be those provided by the system 100. Beginning at block 202, a computing device creates a record based on receiving a request to borrow an asset under a short term loan.

At block 204, the computing device writes an identification of a borrower of the asset to the record based on media drawn from a keycard presented by the borrower. At block 206, the computing device writes identification of the asset to the record and further writes a due date and time for return of the asset under the loan. At block 208, the computing device transmits the completed record to a server for storage and management of the loan. The method 200 terminates thereafter.

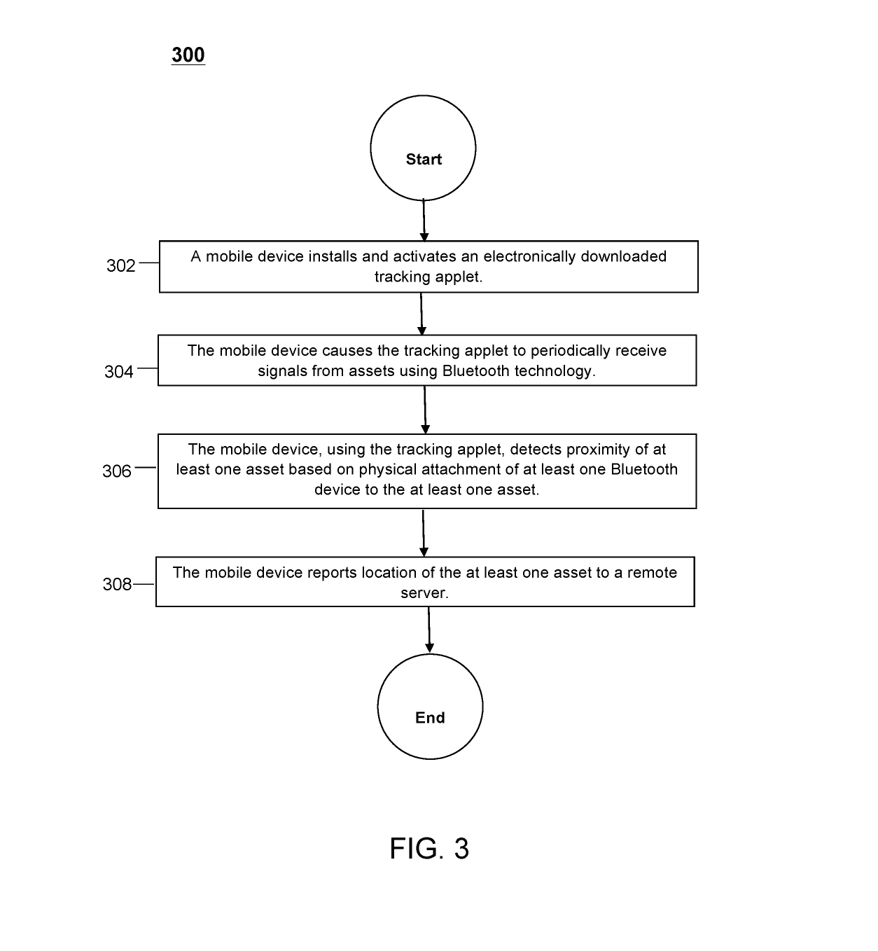

FIG. 3 depicts a flowchart of a method of tracking assets within a geofenced area according to an embodiment of the present disclosure. FIG. 3 depicts a method 300 wherein the components of the method 300 may be those provided by the system 100. Beginning at block 302, a mobile device installs and activates an electronically downloaded tracking applet.

At block 304, the mobile device causes the computing device to periodically receive signals from assets using Bluetooth technology. At block 306, the mobile device, based on actions of the tracking applet, detects proximity of at least one asset based on physical attachment of at least one Bluetooth device to the at least one asset. At block 308, the mobile device reports location of the at least one asset to a remote server. The method 300 terminates thereafter.

In an embodiment, systems and methods provided herein may be used for applications that do not involve short term loaning of assets 114, 116 and may instead be used for theft prevention applications. A retail establishment, for example, may attach tags 126, 128 to its assets 114, 116 that are goods for sale. The discussion above regarding guests and keycards 158, 160 would not apply in this embodiment. The tag 126 would still contain the RFID device 138 permitting alarming if the retail item is removed from the retail establishment. The tag 126 would further still contain at least the Bluetooth device 146 that would permit Bluetooth signaling generated by the Bluetooth device 146 to be tracked and followed after the retail item has been removed from the retail establishment. The retail item could be recovered even if it is no longer inside the retail establishment.

The server 102 may be a general purpose computer. The general purpose computer comprises at least a processor or central processing unit (CPU), read-only memory, random access memory, data storage, and input/output devices. The computer may also comprise network interface cards (NIC) to communicate on a local area network (LAN) and other hardware promoting communication over wide area networks and the Internet.

In embodiments, the server 102 may not be a general purpose computer and may instead be a specialized computer or computers with hardware, software and communications apparatus particular to the needs of the application 104, the database 108, the website 106, the network 172, and other components of the system 100. The network 172 comprises one or more private or public networks, including the Internet, that may be configured in various manners to satisfactorily implement the teachings of the present disclosure.

Although the above descriptions set forth preferred embodiments, it will be understood that there is no intent to limit the embodiment of the disclosure by such disclosure, but rather, it is intended to cover all modifications, substitutions, and alternate implementations falling within the spirit and scope of the embodiment of the disclosure. The embodiments are intended to cover capabilities and concepts whether they be via a loosely coupled set of components or they be converged into one or more integrated components, devices, circuits, and/or software programs.

What is claimed is:

1. A system for tracking assets with a geofenced area, comprising:
a processor;
a memory;
a geofence application stored in the memory that when executed on the processor:
receives a first message from a client device located at a remote premises, the first message containing a record of a short term loan of an asset by the premises, the record further containing a first data item and a second data item,
stores the record in the database, the record associating the first data item, the second data item, and identification of the premises and further describing a due date and time for return of the asset under the loan,
receives a second message from the client device indicating return of the asset, and
converts the record to closed status based on receipt of the second message.

2. The system of claim 1, wherein the first data item identifies a temporary user of the asset under the short term loan and wherein the second data item identifies the asset itself.

3. The system of claim 1, wherein the first data item is gathered from radio-frequency identification (RFID) information provided by the temporary user of the asset and RFID information stored in a first electronic device physically attached to the asset.

4. The system of claim 1, wherein the second data item is gathered from a second electronic device using Bluetooth technology and physically embedded in the asset.

5. The system of claim 1, wherein converting the record to closed status indicates release of the temporary user from responsibility for the asset

6. The system of claim 1, wherein the geofence application maintains accounts for a plurality of assets owned by a plurality of individual premises associated with at least one of lodging and resort operators, healthcare institutions and educational institutions.

7. The system of claim 6, wherein individual premises remotely access the geofence application to view the accounts.

8. The system of claim 4, wherein in the event the asset is removed from the premises prior to receipt of the second message, the client device receives a signal associated with the second electronic device.

9. The system of claim 1, wherein visitors to the premises receive an applet from the premises on mobile devices carried by the visitors, the applet causing the mobile devices to receive Bluetooth signals associated with certain assets on the premises.

10. A method of tracking assets within a geofenced area, comprising:
a computing device creating a record based on receiving a request to borrow an asset under a short term loan;
the computing device writing an identification of a borrower of the asset to the record based at least on media drawn from a keycard presented by the borrower;
the computing device writing identification of the asset to the record and further writing a due date and time for return of the asset under the loan; and
the computing device transmitting the completed record to a server for storage and management of the loan.

11. The method of claim 10, wherein identification of the asset comprises data extracted from RFID media and Bluetooth media physically attached to the asset.

12. The method of claim 10, further comprising configuring the computing device to receive signals within a defined physical premises to locate the asset.

13. The method of claim 12, further comprising configuring the computing device to learn of a location of the asset based on signals associated with the Bluetooth media attached to the asset.

14. The method of claim 12, further comprising the computing device receiving signals to locate the asset based on non-return of the asset under terms of the short term loan.

15. The method of claim 10, further comprising the computing device notifying the server upon not learning of a location of the asset to arrange potential charging of an account of the borrower for the loss of the asset.

16. A method of tracking assets within a geofenced area, comprising:
a mobile device installing and activating an electronically downloaded tracking applet;
the mobile device causing the tracking applet to periodically receive signals from assets using Bluetooth technology;
the mobile device, based on actions of the tracking applet, detecting proximity of at least one asset further based on physical attachment of at least one Bluetooth device to the at least one asset; and
the mobile device reporting location of the at least one asset to a remote server.

17. The method of claim 16, further comprising the mobile device receiving instructions from the server regarding recovery of the at least one asset.

18. The method of claim 16, wherein the tracking applet is received by the mobile device as part of a larger software download provided by an institution associated with the at least one asset.

19. The method of claim 18, wherein the at least one asset is on loan from the institution to a customer of the institution.

20. The method of claim 16, wherein the mobile device causes the tracking applet to receive Bluetooth signals one of when one of on and off a physical premises of the institution and locate the at least one asset when the at least one asset is situated one of on and off the physical premises.
